(19) United States
(12) Patent Application Publication
(10) Pub. No.: US 2004/0172313 A1
(43) Pub. Date: Sep. 2, 2004

(54) System and method for processing health care insurance claims

(76) Inventors: Robert Gary Stein, Marblehead, MA (US); Paul John Brusil, Beverly, MA (US); Nancy Roguski Brusil, Beverly, MA (US)

Correspondence Address: Ralph D. Gelling, 11 River Street, Wellesley Hills, MA, 02481, US

(21) Appl. No.: 10/775,346

(22) Filed: Feb. 10, 2004

Related U.S. Application Data
(60) Provisional application No. 60/446,638, filed on Feb. 11, 2003.

(51) Int. Cl. G06F 17/60

(52) U.S. Cl. 705/4

(57) ABSTRACT

A system for processing health care insurance claims is constructed in which the bulk of the claims processing burden is distributed to a server located at the office of the care provider. Patient data relative to patients under a provider's care is downloaded to the provider server with adjudication software required by the patient's insurance coverage. Claims adjudication occurs in real time at the provider.

### RELATED APPLICATION

This application claims the benefit of U.S. Provisional application No. 60/446,638, filed Feb. 11, 2003.

### BACKGROUND OF THE INVENTION

1. Field of the Invention

The application relates to a system and method for processing health care insurance claims with the majority of processing performed on the service provider's, office based, computer system. In particular a system for processing claims related to dental care.

2. Brief Description of Related Developments

Although the system and method of this application may be applicable to health care claims in general, the system is described below in the context of dental care for simplicity.

The health care industry, in particular in the field of dentistry, is mired in the complexity of administering insurance claims for the patient. The delivery of services has been improved by advanced technologies, such as digital x-ray imaging and many others, but the processing of insurance claims is still dependent in large part on paper which, at least in part is reviewed processed and tracked by staff both at the carrier and at the provider. This antiquated, time consuming, and complex, system requires significant expenditures on overhead in addition to the direct cost of delivering patient care. It is estimated that the cost of processing a single claim transaction is over $25. For comparison a single Internet purchase transaction with a credit card is estimated to cost only pennies.

Currently, patients can wait weeks to obtain those services requiring verification of service need and pre-estimation of payment responsibilities, dentists often wait months to obtain payment for their services and patients often receive final bills for their payment responsibility months after care is received. Confusion and frustration is rampant and this detracts from an otherwise efficient and high quality delivery of patient care.

The system that prevails today in the dental care industry is illustrated schematically in FIG. 1. In this system, care providers 1 provide dental services to patients 10. Prior to performing the service, the administrators in the dental office must ascertain whether or not the patient has coverage, the extent of the coverage, the cash amount of benefits currently available, and an estimate of what will be paid by the carrier 7. This can be done only as an estimate pending carrier review. The patient's financial responsibility cannot be assessed until final carrier settlement of the claim. The payment cycle to the provider is extended because a bill for the patient's balance cannot even be sent until months after the service is completed. Cash flow becomes a constant concern for providers.

To initiate the payment process, a claims form for a particular claim transaction is generated and sent to the carrier. This can be accomplished in different ways, by telephone (fax) 3, post office 4, and electronically over Internet 5 or other network communications. When received by a carrier 7, the claim is processed generally by staff who enter the claim data in a computer system 8 at the carrier 7. Each carrier have established criteria for payment of claims generally by category, type of service and attending service provider; and, more recently these criteria are reduced to algorithm form so that payment adjudication can be accomplished by computer processing. The data input for such processing is required to be in a particular format that is different for each carrier.

The complexities of this system become apparent when it is considered that there are many different insurance carriers with a wide variety of insurance plans. Each plan may have different criteria for payment with the final payment also being diverse. Each of the carriers has a different process for submitting claims. The carriers attempt to keep dental offices up-to-date on new plans and procedures, but the end result is that at least one dedicated staff person is needed in a typical dental office to administer claims processing and that individual must keep aware of all of the plans and procedures. The burdens on the dental office become overwhelming for smaller practices and extremely costly for patients and dentists in general.

The situation associated with electronic claims submissions is similarly problematic. Electronic claims are typically generated by practice management systems at providers and are routed by such systems to associated clearing houses that typically charge both providers and carriers for each individual transaction whether or not they are bundled into a batch. Some carriers allow providers to send individual claims directly, but the interface to the carrier requires manual entry and attention by provider staff.

The process complexity is compounded when the services provided are more advanced than common preventive dental care, such as restorative procedures and major surgery. In these instances, a pre-estimation review process is needed prior to beginning the particular complex care. Supporting documentation, including x-rays and explanation may be required. In these situations, the claims process becomes extended in time and cost.

The administrative burdens of this system for the dentist, patient, and carrier are wasteful, inefficient and delayed. Just keeping track of claims in process, payments by carriers, and patient accounts is the subject of complex administrative computer systems that generate their own burdens in a busy dental office.

Interfaces 2, 6, and 9, are shown in FIG. 1 and represent processing points in which staff are involved. Interface 2 represents the internal office staff and computer support in each dental office. Interface 6 represents the staff required by the carrier to interface with the care providers and interface 9 represents the staff required by the carrier for dealing with its customers and also that required by the dental office for dealing with the customers.

It is a purpose of this invention to improve the processing of claims in health care and in particular dental care by advancing the use of computer processing and thereby reducing the need for human intervention.

There have been many attempts to gain control of the health care claims processing nightmare. Many of these attempts seek to encompass the present system in a gargantuan network, which is designed to centralize the process in a single server. Such a system is described in U.S. Pat. No. 5,301,105 which seeks to process all health insurance claims through a centralized processing system 10 (see FIG. 2). The centralized processing system 10 is connected, via a network, to patient data bases 16-22 and 44, physician office terminals 11, insurance companies 24 and a variety of other resources. This is a rather ambitious attempt to computerize, not only claims processing, but payment through banks, diagnosis, and monitoring of care. At the present there is no database that would serve the purposes of this system. Each of the insurance carriers have their own computer format for the data they maintain. Such diverse data formats are not easily combinable into a giant all knowing database, as contemplated in the '105 patent. U.S. Pat. No. 5,235,507 describes a system for managing health care insurance that is designed for use by a carrier and other administering groups such as employers. The '507 patent recognizes the need to perform the basic claims processing steps of: verifying the insurance status of the claimant; identifying the appropriate insurance policy; calculating the carrier and patient amounts to be paid to the health care provider; paying the provider; calculating the payment required by the claimant, if any; and debiting the account of the claimant in the amount required. It is indicated that a claim may be processed under more than one policy where appropriate. The system of the '507 patent claims to be able to handle both individual and family insurance policies. Although it might be useful to a health plan administrator, it does little to improve the payment efficiencies. It oversimplifies the processes of payment adjudication and is silent on the resources necessary to perform the various tasks that it proposes. Since there is an indication of using this system to process claims covered by multiple insurance companies it seems to assume the availability of an overall centralized database. As indicated above, such a universal database does not exist.

A system that is based on authorization of a credit card transaction is described in U.S. Pat. No. 6,208,973. This system appears to be resident in parts on an adjudication server that is remote from the provider and accessible over the Internet through a credit card transaction server, such as a bank. The bank obtains authorization for debiting the credit card account of the patient through interaction with an adjudication engine having parameters set up for each carrier. The adjudication engine, remote from the provider, uses data from a centralized grouping of databases having patient information and general healthcare resources. This system assumes, not only a universal database, but also a universal adjudication process that is acceptable to all carriers. This is not possible in today's competitive climate between carriers and is likely to be as illusive as an overall patient database that crosses carrier boundaries.

It is a purpose of this invention to provide a system that uses existing databases and authorization adjudication algorithms that are made resident on providers' computer systems. Such a system would only require the downloading of patient data for the specific patients of the provider and not require a universal database or adjudication processing.

Viewing the progress of universal health care and other programs, there is a significant stumbling block in the assumption that carriers will come together to share customer health care data and algorithms in a standardized form. Although this may be an admirable goal, it does not appear to be obtainable in the foreseeable future.

It is a purpose of the system of this invention to provide a system that relies on existing databases to adjudicate claims without the need to create a universal database amongst carriers.

It is another purpose of the system of this invention to provide a secure, distributed, real time system that shares and distributes the cost of claims processing by using idle processing power available on providers' computer systems. It is also a purpose of the system of this invention to provide distributed, real-time expert review services as part of a provider centralized system.

An additional point to be noted with respect to the above prior systems is that none of the references cited above adequately address the security and privacy of the patient healthcare information. Recent regulatory action in the form of the Health Insurance Portability and Accountability Act of 1996(HIPAA) has mandated standards of privacy and security in the storage, use and transmission of patient health care data. It is a purpose of the system of this invention to provide a system which facilitates compliance with the HIPAA requirements.

### SUMMARY OF THE INVENTION

This system described in this application is for use on a computer system located in the office of the service provider. This makes the service provider's system the central point of real-time claims processing instead of relying on a batch processing in a mega-system at a carrier or other location as proposed in prior art solutions. Demands on a carrier's computer system resources will be reduced and more efficiently utilized. This will result in a reduced cost and the option to reallocate such resources to other tasks. At the outset, it is apparent that, the data needed for the processing of claims is limited by the practice of the provider. The size of this database, therefore, is manageable by personal computers available today and already present in a majority of dental offices.

Patient data including, patient identification, subscriber identification, carrier and policy information, and payment/service history, is downloaded to the provider system from existing sources that rely on the up to date database at each carrier. Such downloaded data is stored in memory accessible by the provider's computer system. This download can be accomplished by direct telephone connection to the parent database or more particularly via a secure Internet link. A patient's information would be kept up to date as claims are processed or as patient data is otherwise changed.

Claims adjudication software is obtained from each carrier for the insurance plans under which a provider services its patients. This software is continually updated to enable the provider system to input and process claims using the patient data. Accurate adjudication of a carrier payment is, therefore, obtained at the point and time of service, allowing patient responsibility to be immediately and reliably allocated and assessed.

A payment request resulting from the adjudicated claim would be sent to the carrier for payment by electronic transfer. In the dental care industry, the majority of services performed are well categorized and commonly performed on a regular basis. The vast majority of claim decisions will not require review by the carrier and provider based processing will be accurate and efficient. An audit function can be used to periodically check transactions to insure maintenance of such accuracy. The patient will know their cost at the beginning and can be billed or payment obtained on the spot. Carrier payment will be accelerated considerably, resulting in much improved cash flow for the dentist or other care provider.

To accomplish this a server is constructed and installed at the provider having the processing capability, software, communication media access modules, and storage media sufficient to accomplish the transaction volume of a particular dental office. This may require additional or updated computer capability. A carrier server is provided with complementary processing capability, software, communication media access modules and storage media compatible with the provider server. This is accomplished using existing resources. Since the carrier server has a substantially reduced claims processing load because of the distribution of this burden to provider systems a savings in computer resource investment can be realized. The carrier need only process payment requests resulting from claims adjudicated on the provider system. A communication link is established between the provider server and the carrier server, with an update processor of the carrier server acting as a gateway to patient information and adjudication software. Patient data and adjudication software are obtained from the carrier server upon a security controlled inquiry from the provider. With respect to existing patients already on the provider's system, the inquiry may only be in the nature of a check to make sure data and adjudication algorithms are current.

The provider server consists of several operatively associated processors adapted to execute resident software for the accomplishment of particular tasks. Claims transactions are processed in a payment determination processor operated by software designed to perform the steps of claims origination, data and adjudication algorithm acquisition, storage, and maintenance. In addition this processor will perform payment adjudication and allocation according to the carrier algorithms. A single claim transaction may involve primary and secondary carriers. In this situation, the payment responsibility will be allocated between the carriers according to common standards and the adjudication software of each carrier. In this manner the complex and time consuming process of coordination of benefits is realized on a real-time basis. A communication and security interface forms part of the provider server and employs security operations that comply with HIPAA regulations. This interface is the gateway to a communication link adapted to connect to the carrier server.

According to one embodiment of this invention, patient data is obtained at the initial establishment of the patient/provider relation. Basic patient data is presented by the patient for input to the provider server and is obtained from a patient card such as a smart card or the like. Preferably this is a personal health care card issued by the carrier having identifying information personal to the individual patient. The data resident on such a card may become out of date, therefore, upon the initiation of a service event, an update inquiry will be executed. The submitted data will be checked for changes by the provider server through the link to the carrier database. Provision is made to update the card at that time. In this way an accurate service and payment history can be conveniently maintained on the patient card. In this embodiment, a read/write module would form part of the provider system in operable communication with the payment processor.

A carrier payment processing server consists of a group of processors and software modules equipped with software for executing operations complementary to the operation of the provider server. A carrier payment administration processor is connected to the provider server through an appropriately secure communications link and adapted to receive and process the payment request for payment. In addition an update processor is connected to the provider server to process inquiries relating to patient data and adjudication software currency. A communications interface provides the necessary security for the carrier server processors. The update processor is the gatekeeper for access to patient data and adjudication software requested by the provider. The payment administration processor accepts and processes adjudicated payment request transactions, checks them for form and content and submits them for payment through a payment processor associated with the carrier accounting system. Payments will be accomplished by electronic fund transfers.

In another embodiment, the system provides for the processing of more complex claims for which expert review is required according to adjudication algorithms. To accomplish this an expert review processor is established on the provider server. The payment determination processor at the provider server will initiate expert review in which the provider expert review processor will generate a file containing the necessary patient data, including treatment plan and justifying materials. Justifying materials would include x-rays and dental analysis, and other supporting information. Review guidelines relevant to the patient, provider and carrier would also be provided as part of the treatment plan file. This file is isolated for access through secure channels via a communication link. The provider server initiates a call for expert review, which can be accessed by reviewers designated by a carrier. A reviewer will accept the transaction and, through the secure channels, obtain the necessary data and guidelines from the provider carrier processor. A decision on the proposed service is promulgated by the reviewer and returned to the provider for processing. In the majority of cases, the claims transaction can be completed at this junction with an appropriate claim adjudication. This avoids significant delays in seeking expert review, submitting supporting documentation, and obtaining a determination. As in the simple case above, the adjudicated payment request transaction would be sent to the carrier for checking and payment.

A carrier expert processor is associated with the carrier server to provide a listing of expert reviewers and updated guidelines for expert review and for checking the accuracy of the review process.

### BRIEF DESCRIPTION OF THE DRAWINGS

The health claims processing system of this invention is explained in more detail below with reference to the accompanying drawings, in which:

FIG. 1 is a schematic diagram illustrative of the complexity of prior art health claims processing in general;

FIG. 2 is a block diagram of a prior art solution to the problem of slow and inefficient claims processing;

FIG. 3 is a block diagram of a the claims processing system of this invention;

FIG. 4 is a block diagram of the provider server of the system of this invention;

FIG. 5 is a block diagram of the carrier server of the system of this invention;

FIG. 6 is a flow diagram of the process at the provider;

FIG. 7 is a flow diagram of the currency updating process at the carrier;

FIG. 8 is a flow diagram of the payment request process at the carrier; and

FIG. 9 is a flow diagram of the expert review guidelines support process at the carrier.

### DESCRIPTION OF THE PREFERRED EMBODIMENT

The following discussion is intended to provide a brief, general description of a suitable computing environment in which the invention may be implemented. The invention is described in the general context of computer-executable instructions, such as program modules, being executed by a personal computer or network server. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, network PCs, minicomputers, mainframe computers; and the like. Certain functions of the invention may also be practiced in distributed computing environments where tasks are performed by remote processing devices that are linked through a communications network. In some instances, program modules and data used by such modules may be located in both local and remote memory or other storage devices.

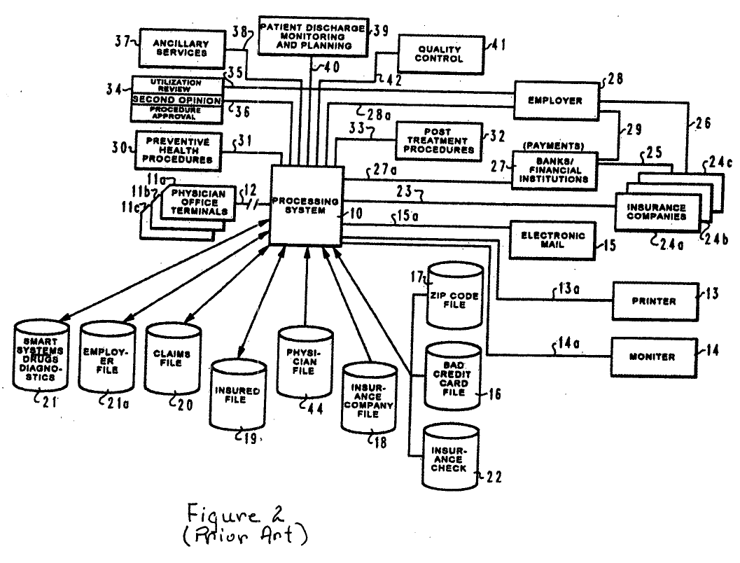

This system described in this application is for use on a computer system 1 located in the office of a health care service provider, such as a dentist. The service provider's system 1 is the central point of real-time claims processing as opposed to an approach based on queuing up claims transactions for batch processing in a mega-system at a carrier or other location as proposed in prior art solutions, such as shown in FIG. 2. The claims processing burden is distributed to the computer resources located at each dental office.

Although the invention is described using dental care as an example, the system of this invention may be adapted to any type of health care or other service that relies on insurance or third party payments for a large part of payments for health care services.

Patient data shall refer to patient identification, subscriber identification, policy and carrier information, and payment/service history. Patient data may also included claims adjudication software depending on the form of the data source. Patient data may include electronic addresses from which to obtain patient data, adjudication software and updates to both. Also included is security information such as signatures and certificates to verify the origin and authenticity of patient data and to decode protected patient data.

Patient data is downloaded to the provider system from existing portable sources, such as data cards and the like. Such sources could also be secondary data bases associated with a third party billing and claims administration processor that may be employed by the provider to administer claims transactions under existing complex procedures and data bases accessible by Internet access from third party or supplemental carrier sites. Patient data from all sources relies on an up to date authoritative, parent database 23 maintained by each carrier, employer or third party administrator or any such resource that may become available. Such downloaded data is stored in memory accessible by the provider's computer system 1. This download can be accomplished by local read/write module 35 in the case of a portable data card and a communication link 32 which may be a direct telephone connection to the parent database 23, a secure Internet link or other type of link. A patient's information would be kept up to date as claims are processed or as patient data is otherwise changed. New, patient-related information created locally at the provider would be uploaded to the patient data storage medium 25 and to the parent patient data base 23.

Claims adjudication software 22 is obtained from each carrier for the insurance plans under which a provider services its patients. Such software is stored in a provider's computer system so that it can be accessed when needed to process applicable patient data. This software is continually updated to enable the provider system to input and process claims using the up to date patient data. Accurate adjudication of a carrier's payment responsibility is, therefore, obtained at the point and time of service, allowing patient payment responsibility to be immediately and reliably allocated and assessed at the point and time of service. Adjudicated claim data in the form of a payment request that would include an Explanation of Benefits (EOB) statement and a certificate verifying the authenticity of the adjudication software used to compute the payment request would be sent to the carrier for payment by electronic transfer and to the patient for any patient payment.

In the dental care industry, the majority of services performed are well categorized and commonly performed on a regular basis. The vast majority of claim decisions will not require review by the carrier and provider based processing will be accurate and efficient. By means of the invention, the patient will know the cost at the beginning and can be billed or payment can be obtained on the spot. Carrier payment will be accelerated considerably, resulting in much improved cash flow for the dentist or other care provider.

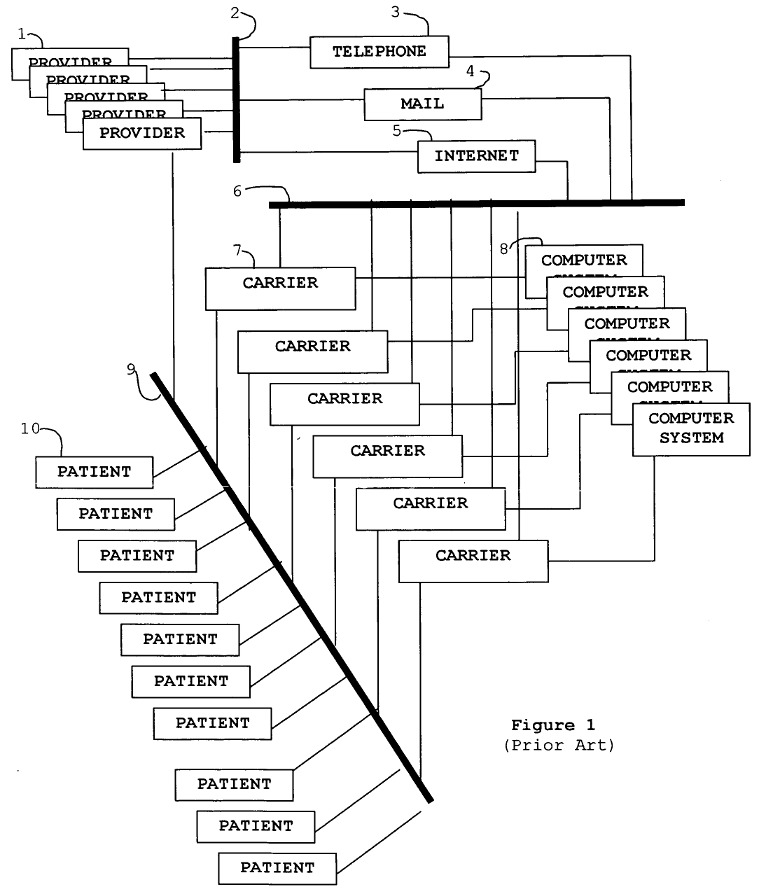

To accomplish the general purposes of this invention, as shown in FIGS. 1,3-5 a source of patient data, such as a patient card 25, with non-volatile data storage capabilities on which is stored the requisite information, is presented to a provider server 20 to enable the downloading of the patient data to the patient database 33 of the provider server 20 within the provider's computer system 1. Provider server 20 is in communication with an insurance carrier's computer system 8 to obtain any needed claims adjudication software or adjudication software updates appropriate to the needs of a particular patient's insurance coverage and to obtain any needed updates to make current the data downloaded from the patient card. A payment server 21, within the carrier computer system 8, provides updated or original patient data 23 and the adjudication software 22 to provider server 20. Depending upon the operation of a patient's coverage, the parent data base 23 containing the authoritative patient data may be located at an employer or third party plan administrator. Provider server 20 is constructed and installed in the provider system 1 having the processing capability, software modules, communication media access modules and storage media sufficient to accomplish the transaction volume of a particular dental office.

Carrier server 21 is provided with complementary processing capability, communication media access modules, software modules and storage media compatible with the provider system.

Patient data and adjudication software are obtained from the carrier server 21 through a communication link 32 that is security controlled according to the privacy and security requirements of governmental regulations, such as HIPAA.

The provider server 20 consists of several operatively associated processor modules adapted to execute resident software for the accomplishment of particular tasks. Through an application interface 39 the provider server can interact, using provider system 1 with means, such as inter-process communication capabilities, with a third party billing and claims administration processor 26 which contains software and certain patient data that may be as currently employed in most dental offices to administer claims transactions. User interface 34 is constructed having means, such as a keyboard, to input text or commands, as well as a display to present menus and other information to the user. User interface 34 could be a personal computer connected to a network with access to the payment determination processor 27 in the provider server 20 via communications link 32.

Claims transactions are processed at the provider in a payment determination processor 27 operated by software designed to perform the steps of claims origination, data and adjudication software acquisition, authenticity verification, storage, and maintenance. In addition processor 27 will perform eligibility determination, expert review initiation, coordination of benefits initiation, payment adjudication and allocation according to applicable carrier adjudication software 22, and payment request creation and submittal.

In some instances, a single claim transaction may involve primary and secondary carriers. In this situation, the payment responsibility will be allocated between the carriers according to common standards and the adjudication software of each carrier, thereby allocating payments relative to the priority of carrier responsibilities. In this manner the complex and time consuming process of coordination of benefits is realized on a real-time basis.

Communication and security interfaces 31 and 41 form part of the provider server 20 and carrier server respectively, and employ security operations that comply with HIPAA regulations. These interfaces are the gateway to communication link 32 adapted to connect the carrier server 21 to the provider server 20. As per HIPAA regulations, security operations are used to protect and to keep private any data in transit, in processing or in storage that contain patient-identifiable information. Pertinent to such data and the software that use, store and convey such data, security mechanisms exist to authenticate the source and recipient of such data and software, to assure the authenticity of such data and software, to identify entities reading and updating the data and software, to prevent the reading and updating of data and software by unauthorized entities, to hide the data from plain view, to prevent masqueraded attempts to steal service or to fraudulently bill for services not rendered, to prevent the repudiation of services received or associated bills/payments, and to capture and log suspicious activity associated with such data and software. Pertinent to such data and such software that use, store or convey such data, security interfaces 31 and 41 are constructed to use a variety of common, widely-available computer security, information technology security and network security mechanisms, such as encryption, digital signatures, security certificates, pass words, biometrics, check sums, intrusion detection and so on to provide the above security operations.

According to one embodiment of this invention, patient data is obtained by the provider upon establishment of the patient/provider relation. Basic secure patient data is presented by the patient for input to the provider server 20 and is obtained from a patient card 25. Patient card 25 can employ any of the available portable, patient-carried, devices with non-volatile storage capabilities including memory cards, memory sticks, smart cards, mini flash drives and similar devices with other storage technology. Preferably this is a personal health care card issued by the carrier, employer, or third party administrator and contains encrypted patient data, personal to the individual patient. A read/write module facilitates operable communication between the patient card 25 and the payment determination processor 27. The downloaded data is stored as appropriate in patient data base 33 and the adjudication software storage 36 of provider server 20. Depending on the available memory , the patient data may be stored only for the limited period of a particular service transaction to conserve the memory resources of provider server 20.

Upon the initiation of services, encrypted patient data will be read into the provider server 20, by means of an appropriate read/write module 35, data authenticity will be verified and data will be stored in secure databases 33 and 36, whichever is applicable. An update inquiry is executed by update processor 37 to check the up to date currency of the presented data through carrier server 21. The submitted data will be checked for changes and updated by secure updates triggered by comparison to patient data at the parent data base 23 and comparison to parent adjudication software 22. Provision is made to allow patient data and adjudication software update processor 37 of provider server 20 to securely update the patient card 25 at that time via the read/write module 35. In this way accurate and complete patient data including: service and payment history, patient and subscriber identification information and policy information can be conveniently maintained on the patient card.

After the claim is processed by payment determination processor 27 according to the related adjudication algorithms from memory 36, a payment request including an accompanying EOB and a certificate verifying the authenticity of the adjudication software used to compute the payment request are generated for electronic submittal to the carrier server 21. This payment request is in a form to be processed for payment and is the equivalent of a bill submitted for payment to the carrier.

A carrier server 21 consists of a group of processors and software modules for executing operations complementary to the operation of the provider server. A carrier payment administration processor 40 is connected to the provider server 20 through an appropriately secure communications link 32 and adapted to concurrently receive and process secure payment requests.

Processing of payment requests is handled by payment administration processor 40 which decrypts and verifies the authenticity of received information, checks the decoded payment requests for form and content and submits them for settlement and payment via carrier payment processor 44 associated with the carrier accounting system. Payments will be accomplished by electronic fund transfers or other mechanisms.

Payment administration processor 40 also enters received payment requests and records of payment settlement receipts as updates to the secure, authoritative, parent, patient data base 23. Payment administration processor 40 also triggers and cooperates with local and remote trusted audit processors 49 and 38, respectively, to periodically check payment requests, adjudication results, and explanatory EOBs to insure maintenance of accuracy and fraud-free operations, to support payment tracking, to detect service delivery pattern changes and trends, and to support detecting potentially fraudulent service patterns.

In addition, an update processor 45 is connected to the provider server 20 to process inquiries from update processor 37 of the provider server 20 relating to currency of patient data and adjudication software at provider server 20. As the gatekeeper for access to authoritative patient data and adjudication software, the update processor 45 of carrier server 21 securely downloads back to the inquiring provider processor 37 any new or modified data and software that are required to update patient data stores in data bases 33, 36 and patient card 25.

A communications and security interface 41 provides the necessary remote connectivity and security for the carrier server processors.

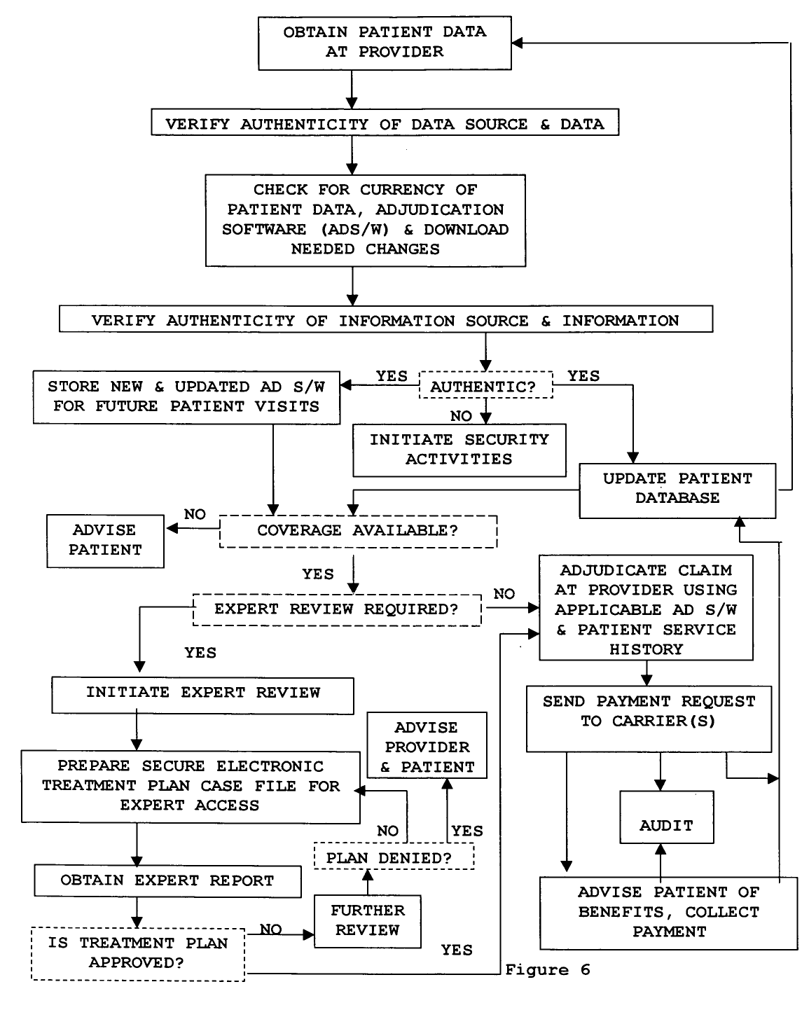

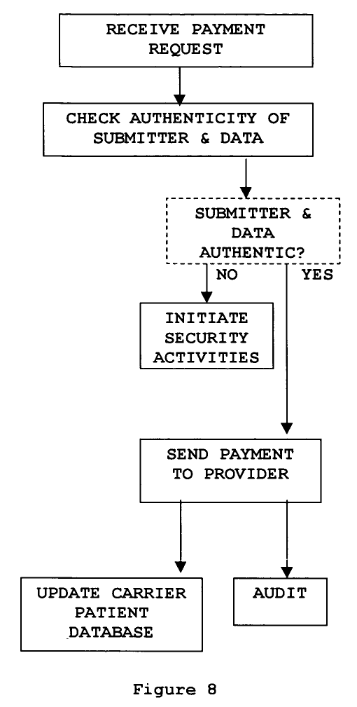

Referring to FIGS. 6-9, the operation of the system of this invention begins with the acquisition of patient data at the provider server 20, as described above, from portable patient cards or from carrier patient data bases or local patient files. At the outset the provider server 20 will, if necessary, decrypt and use associated security certificates to check the authenticity of the data source and the data provided. If authenticity verification fails, security logs are updated to reflect information about suspicious activities and appropriate other security activities may be initiated to further protect the provider server or to deal with such suspicious activities. At this point additional forensic security procedures may be employed to determine validity, source, and other aspects of the failure. Once authenticity is assured, patient data is moved into appropriate local data stores 33, 36 within the provider server and, as necessary, is decrypted prior to its use in the provider server.

Prior to their use by processor modules in the provider server, all patient data 33 and all adjudication software applicable to the processing of the specific patient's service must be checked for currency by comparison to data in database 23 and adjudication software 22 available at the carrier server 21. As necessary, complete data files, data file updates, complete adjudication software routines, or adjudication software updates are sent by the carrier server 21 to the provider server 20. The provider server 20 via update processor 37 authenticates the information sending sources and the information sent, updates local stores 33, 36 and patient card 25 with appropriate received information.

The payment determination processor 27 extracts applicable policy parameters and patient service history data from the up to date patient data store 33 to determine whether policy coverage is available. This would include a screening of a proposed service regarding eligibility for carrier payment. Once the patient data file 33 and all applicable adjudication software file 36 is complete, verified and updated, if necessary, and basic eligibility determined, the provider may move forward with a plan of treatment. This is accomplished in real time immediately prior to beginning treatment. Providing the treatment is routine and not complex, the payment responsibility can be determined by payment determination processor 27 executing the adjudication software in memory 36. A payment request for the carrier's responsibility is sent to the carrier for payment and the patient is provided with an EOB and a statement of his allocated charges upon which payment is due. The payment request will prompt updating of the carrier patient data base 22. It should be clear that this is accomplished in real time and payment to the provider is obtained both from the carrier and the patient in a significantly expedited manner.

For treatment plans that call for the performance of more complex treatment such as surgery, crowning and the like, it may be necessary to obtain independent expert review of the treatment plan for carrier coverage to apply. In this instance, a secure file is created, containing the treatment plan and supporting documents and stored in segregated memory 28. An expert, authorized by the carrier and assigned to the treatment plan, remotely accesses the treatment plan file and reviews the plan for payment according to standards set up by the carrier. If more information is requested the treatment plan is supplemented with additional justifications to assure that the service proposed in the treatment plan is consistent with the evidence provided in the treatment plan and the secure, segregated, treatment plan file is accordingly updated for further review. When the treatment plan is approved the payment responsibilities can be allocated in an EOB as described above and a payment request can be made.

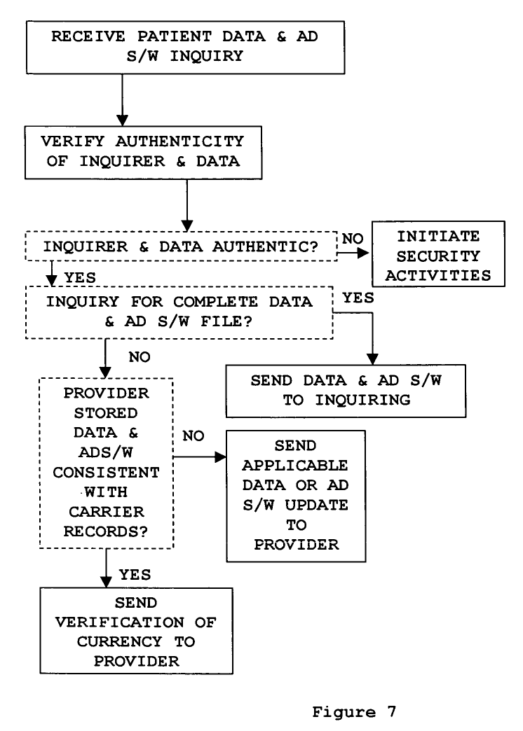

The processes that are executed at the carrier server 21 are significantly simplified, as shown in FIGS. 7-9. The carrier server 21 executes software in various modules to support the downloading, authentication, security, and updating of patient data and adjudication software at the provider server 20. Upon the receipt of a patient data and adjudication software inquiry, the authenticity of the inquirer and any data conveyed from the inquirer is checked. Authenticity failures trigger further security measures including notification of the provider and patient, if warranted. Properly authenticated inquiries are checked by the update inquiry processor 45 to determine if they are inquiries for complete patient data files or complete adjudication software, or whether they are inquiries to check for the currency of data and software currently available at the provider server. If the former, the patient data and adjudication update inquiry processor retrieves the complete requested data and/or adjudication software files from appropriate data bases, 23 and 22 respectively, and securely sends such files to the inquiring provider server. If the inquiry is for currency checking, the patient data and adjudication update inquiry processor determines whether the data and adjudication software at the inquiring provider server are up to date with the authoritative stores, 23 and 22 respectively, at the carrier. If the data 33 and adjudication software 36 at the provider server 20 are in synchrony with the authoritative, up to date data stores 23, 22 at the carrier server, the patient data and adjudication update inquiry processor 45 securely sends verification back to the inquiring provider server.

If the patient data 33 and adjudication software 36 at the provider server 20 are not consistent with the data of data bases 23, 22, the update inquiry processor 45 determines and securely sends appropriate data and software updates back to the inquiring provider server.

When a payment request is received by the payment administration processor 40 at the carrier server 21, the payment administration processor 40 checks the authenticity of the submitter and the submitted data. If the authenticity check fails, security activities as above are initiated. If they are authentic, the payment administration processor sends the payment request to the carrier payment processor 44 for payment settlement. The payment administration processor extracts relevant data from the payment request, appropriately updates the carrier's secure data base of patient data 23 with such relevant data and sends a notifying update with such relevant data to the audit processor 49.

Coordination of Benefits

In many instances, a patient may have multiple insurance policies from several carriers that, based on the source of the insurance, i.e. from a spouse, etc., will have different payment responsibilities. The carriers will have assigned priorities as to the order and amounts of payment responsibilities. For multiple policies, the coordination of benefits processor 30 ensures the cycles of operation, such as data loading, update inquiries, authenticity verification, adjudication and payment request generation are necessarily repeated for each carrier. The coordination of benefits processor 30 ensures payment responsibility for each carrier will be determined using the patient data and adjudication software applicable to the particular carrier and in the proper relative order. Carrier identification, forming part of patient data, provides the necessary information to contact and segregate the carrier specific patient data and adjudication software. Appropriate priority routines will be executed by coordination of benefits processor 30 to prioritize the payment responsibilities according to known standards.

Expert Review

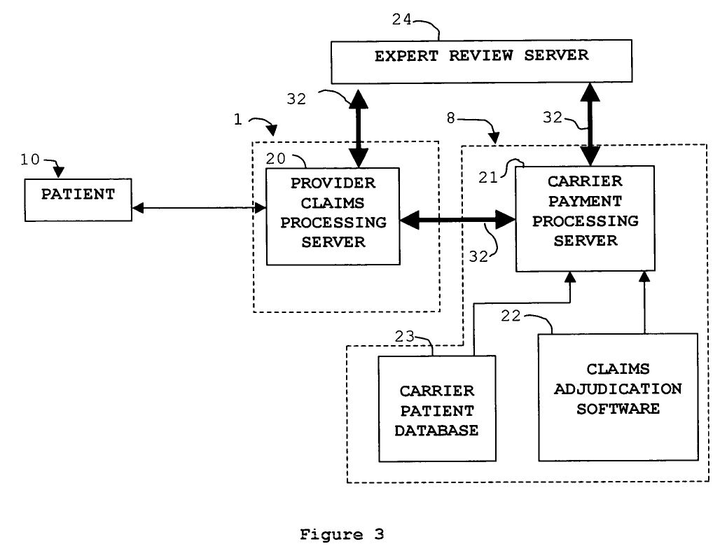

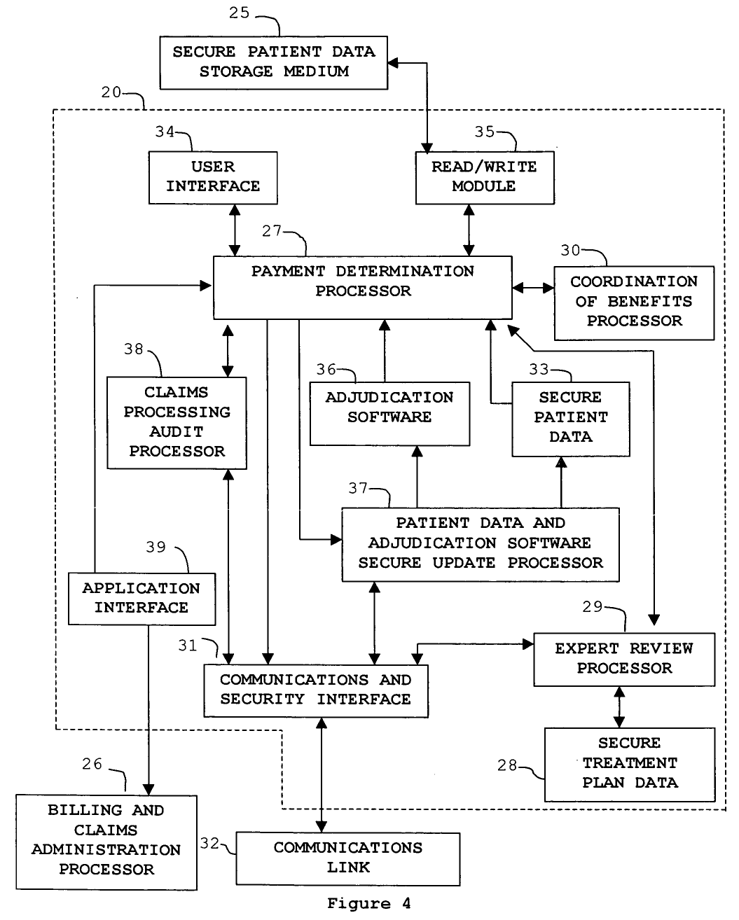

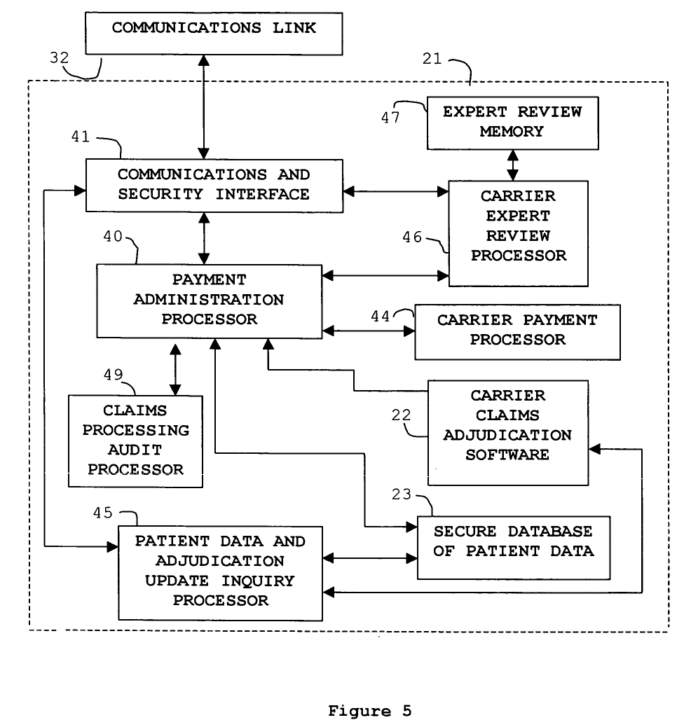

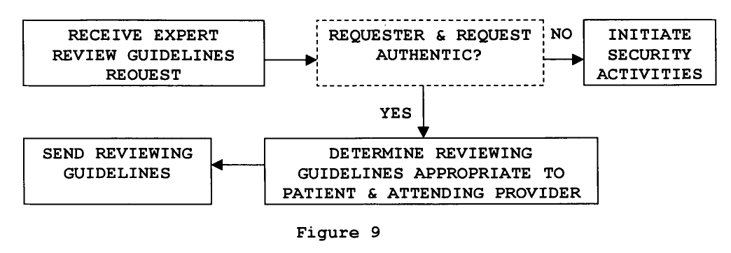

As shown in FIGS. 3-5 and the flow diagram of FIGS. 6 and 9, the system of this invention also provides for the processing of more complex claims for which expert review is required according to the carrier policy in effect for a patient. To accomplish this, a provider expert review processor 29 is established in the provider server 20. Provider expert review processor 29 operates in conjunction with a segregated memory module 28. Memory module 28 stores secure data relating to a provider-proposed service that requires expert review. The provider generates a treatment plan using interface 34 through processor 27. The treatment plan includes a detailed description of the proposed treatment and supporting data, for example digital X-rays and provider analysis. The treatment plan is saved in a file that requires security codes for access and this file is sent to segregated secure memory module 28. In this way an expert reviewer can be given limited access to the restricted file without risking unauthorized access to patient data in general. In addition the treatment plan file will include review guidelines relevant to the patient, provider and carrier and such guidelines are to be used by the reviewer in approving the service proposed in a particular treatment plan. This file is isolated in the segregated memory for access only by a designated remote expert reviewer through secure channels via communication link 32. This file could be attached to a highly controlled secure web site created on the provider server and accessible only by the designated expert reviewer's web browser.

As shown in FIGS. 3-5, the expert review system consists of expert review server 24, provider expert review processor 29, and carrier expert review processor 46. The server 24 contains software modules which provide secure communication and controlled access to treatment plans that require expert review, procedures to obtain and to securely distribute reviewing guidelines applicable to a treatment plan, procedures to allow an expert to apply for assignment to a particular treatment plan review, and procedures to assign the review of a specific treatment plan to a specific expert reviewer. The expert review system would be remotely accessed by the expert through a personal computer with a secure communication link to the Internet.

Appropriate application and acceptance algorithms are resident on the server 24 to provide a controlled procedure for acceptance of reviewers and assignment of an expert to a treatment plan to be reviewed. Server 24 could be part of a dedicated web site, set up to service treatment plan reviews for a group of carriers or an individual carrier. Some of these functions could also be distributed amongst a personal computer of an expert reviewer, and the carrier and provider expert review processors.

Expert review server 24 communicates as needed with both provider expert review processor 29 and carrier review processor 46. Carrier review processor 46 provides access to a secure list of approved reviewers stored in memory 47 in addition to review guidelines. Further software modules, may be provided for supporting the expert review function and collecting or using historical data relative to service delivery patterns of providers. The compilation of historical data can be used by the carrier to determine patterns and trends of acceptable practice. With such provider-specific service pattern data, reviewing guidelines can be adapted to greater or lesser degrees of review scrutiny depending on the specific provider's service delivery history. Furthermore, indications of abuse or fraud can be uncovered and audit procedures can be initiated.

In practice, when expert review is required, the provider establishes a treatment plan file with supporting information and stores the file in secure memory 28. If not fully automated, the provider initiates a call for expert review, using interface 34, according to a menu of steps presented on a display. The call for review can be accessed by or automatically assigned to reviewers via the expert review server 24. In the former case, a reviewer can apply to review a particular treatment plan and, if accepted, the treatment plan review will be assigned. Through secure channels, the assigned reviewer will be given access to memory 28 to obtain the necessary data and guidelines from the provider expert review processor 29 . A decision on the treatment plan is promulgated by the reviewer and returned to the provider for processing. In the majority of cases, the payment responsibilities adjudication for services rendered via the approved treatment plan can be completed at this time. This avoids significant delays in seeking expert review, submitting supporting documentation, and obtaining a service delivery go ahead determination. As in the simple case above, the payment request resulting from the completion of the expert-approved service would be sent to the carrier for checking and payment.

Although the foregoing description illustrates the preferred embodiment, other variations are possible and all such variations, as will be apparent to those skilled in the art are intended to be included within the scope of this invention, as defined by the following claims.

We claim:

1. A system for processing health care insurance claims among a health care provider, a patient and said patient's insurance carrier comprising:
a provider server operatively established at the service provider, said provider server further comprising:
a provider storage medium for storing patient data and adjudication software received from a remote source;
a provider payment determination processor operatively associated with said storage medium to process patient data, using said payment adjudication software to obtain an adjudicated payment request;
a provider communication interface for receiving data and sending data including said payment request over an external communication link in a secure manner; and
a carrier server operatively established at the insurance carrier, said carrier server further comprising:
a carrier storage medium for storing an authoritative version of patient data and insurance payment adjudication software;
a carrier payment administration processor for receiving said payment request and causing a payment to be made to said provider in accordance with said claim submittal; and
a carrier communication interface for receiving data including said payment request and sending data over said external communication link in a secure manner; and
wherein said communication link connects said provider and carrier servers through said provider and carrier communication interfaces.

2. A system for processing health care insurance claims, according to claim 1, wherein said provider server further comprises a data reader/writer and wherein said remote source of patient data and adjudication software is a portable device with storage capability and said patient data and adjudication software is downloaded to the provider storage medium by reading said data from said device.

3. A system for processing health care insurance claims, according to claim 2, wherein said portable device is a smart card.

4. A system for processing health care insurance claims, according to claim 2, wherein said portable device is a magnetic media card.

5. A system for processing health care insurance claims, according to claim 1, wherein said remote source of patient data and adjudication software is said carrier storage medium and said patient data and adjudication software is downloaded to said provider server from said carrier server over said communication link.

6. A system for processing health care insurance claims, according to claim 1, wherein said remote source of patient data and adjudication software is an Internet site and said patient data and adjudication software is downloaded to said provider server over said communication link from an Internet site.

7. A system for processing health care insurance claims, according to claim 1, further comprising:
a system for processing claims for treatment plans, wherein said claims require expert review comprising:
a provider expert review processor, operatively associated with said provider server, for securely storing and processing a treatment plan file, said file including treatment plan and supporting data;
a carrier expert review processor, operatively associated with said carrier server, for providing processing and memory resources to support the process of conducting said expert review;
an expert review server operatively associated with said provider and carrier expert review processors through said communication links, for providing processing and memory resources to support the process of conducting said expert review;
further wherein said provider and carrier expert review processors and said expert review server cooperate to provide access to a listing of claims for review, provide processing of applications by experts for reviewing a particular claim, provide assignment of said claim to said expert and provide access by said assigned expert to said treatment plan file to conduct said review; and
an expert review module connected by said communication link to provide a means for said assigned expert to access said provider expert review server, review said treatment plan file, and generate a report.

8. A system for processing health care insurance claims, according to claim 7, wherein said expert review server comprises a web site.

9. A system for processing health care insurance claims, according to claim 8, wherein said web site is on said provider server and accessible through said communication link.

10. A system for processing health care insurance claims, according to claim 1, wherein said provider server further comprises a coordination of benefits processor for processing claims in which the patient is covered by multiple carriers, said processor constructed to identify said multiple carriers, obtain and segregate patient data and adjudication software relative to patient and each carrier, cause said provider payment processor to sequentially process said claims using the patient data and adjudication software of each of said multiple carriers and for allocating the payments to each carrier according to a predetermined priority of said carriers.

11. A system for processing health care insurance claims, according to claim 1, wherein said provider server further comprises a user interface constructed to enable a user to enter data and commands, and to observe a visual display of operational information.

12. A system for processing health care insurance claims, according to claim 1, wherein said provider server further comprises a provider patient data and adjudication software update processor constructed to send an inquiry to said carrier server to obtain a current version of said patient data and adjudication software.

13. A system for processing health care insurance claims, according to claim 12, wherein said provider update processor is adapted to update a portable source of patient data after receiving said current version of said patient data and adjudication software.

14. A system for processing health care insurance claims, according to claim 1, wherein said carrier server further comprises a carrier patient data and adjudication software update processor to process said inquiry from said provider server and send a current version of said patient data and adjudication software to said provider server.

15. A system for processing health care insurance claims, according to claim 14, wherein said carrier patient data and adjudication software update processor is the gate keeper to control access to said carrier storage medium.

16. A system for processing health care insurance claims, according to claim 14, wherein said carrier patient data and adjudication software update processor is constructed to determine whether said inquiries are for complete patient data files or complete adjudication software, or whether said inquiries are to check for the currency of data and software currently available at the provider server, and wherein said carrier update processor is further constructed to send an update or complete patient data and adjudication software package according to said inquiry.

17. A system for processing health care insurance claims, according to claim 1, wherein said provider and carrier communication interfaces provide security functions to protect and to keep private any data in transit, in processing, or in storage.

18. A system for processing health care insurance claims, according to claim 17, wherein said security functions include at least, encryption and decryption, identity verification, and data authentication.

19. A system for processing health care insurance claims, according to claim 1, wherein said security functions comply with HIPAA requirements.

20. A system for processing health care insurance claims, according to claim 1, wherein said carrier server further comprises a carrier audit processor for periodic review of said adjudicated payment requests for accuracy.

21. A system for processing health care insurance claims, according to claim 20, wherein said carrier audit processor supports payment tracking and detects fraudulent service delivery patterns.

22. A computer based method of processing health care insurance claims between a provider server and a carrier server comprising the steps of:
providing patient data and claims adjudication software for storage on said provider server;
adjudicating, at said provider server, a claim relating to a particular service using said patient data and adjudication software stored on said provider server;
generating a payment request at said provider server based on said adjudicated claim;
establishing a secure communication link between said provider and carrier servers;
sending said payment request from said provider server to said carrier server; and
processing said payment request at said carrier server and sending payment from said carrier server to said provider server.

23. The method according to claim 22, further comprising the step of establishing a parent data base containing an accurate, authoritative, current version of said patient data and claims adjudication software.

24. The method according to claim 22, wherein said patient data and adjudication software is downloaded to the provider server by reading said data from a portable device with storage capability.

25. The method according to claim 22, wherein said portable device is a smart card.

26. The method according to claim 22, wherein said portable device is a magnetic media card.

27. The method according to claim 23, wherein said patient data and adjudication software is downloaded to said provider server from said carrier server over said secure communication link.

28. The method according to claim 22, wherein said patient data and adjudication software is downloaded to said provider server over said communication link from an Internet site.

29. The method according to claim 22, further comprising the step of:
processing claims for treatment plans, wherein said claims require expert review, further comprising the steps of:
creating a treatment plan file, said file including treatment plan and supporting data relating to said claim;
storing said treatment plan file in a secure, segregated expert review memory;
securely storing listings of said claims for expert review and guidelines for conducting said expert review;
providing access to said listing and guidelines by authorized expert reviewers to enable the application by an expert reviewer for the review of a particular claim;
processing applications by said experts, selecting an expert with respect to a claim, and assigning a claim to an expert; and
providing access to said treatment plan file to said assigned expert to allow said expert to conduct said review.

30. The method according to claim 29, further comprising the steps of:
receiving a report from said expert authorizing said treatment plan; and
adjudicating, at said provider server, said claim using said report and said patient data and adjudication software stored on said provider server;

31. The method according to claim 29, wherein said steps of said expert review are distributed among an expert review processor on said provider server, an expert review processor on said carrier server, and an expert review server on an Internet site.

32. The method according to claim 31, wherein said expert review accesses, as needed, said provider, carrier, and Internet expert review servers by means of a computer device connected through a communication link.

33. The method according to claim 22, further comprising the step of:
processing claims in which a patient is covered by multiple carriers, further comprising the steps of:
identifying said multiple carriers;
obtaining and segregating patient data and adjudication software relative to said patient and each carrier;
sequentially processing said claims on said provider server using the patient data and adjudication software of each of said multiple carriers; and
allocating the payments to each carrier according to a predetermined priority of said carriers.

34. The method according to claim 23, further comprising the steps of:
sending an inquiry from said provider server to said carrier server to obtain a current version of said patient data and adjudication software based on said authoritative, parent, data base; and
receiving said inquiry at said carrier server and sending a current version of said patient data and adjudication software to said provider server.

35. The method according to claim 34 further comprising the step of updating said portable device with storage capability after receiving said current version of said patient data and adjudication software.

36. The method according to claim 34, further comprising the steps of:
determining whether said inquiries are for complete patient data files or complete adjudication software, or whether said inquiries are to check for the currency of patient data and software available at the provider server, and
sending an update or complete patient data and adjudication software package according to said inquiry.

37. The method according to claim 22 further comprising the step of providing security functions to protect and to keep private any data in transit, in processing, or in storage.

38. The method according to claim 37, wherein said security functions include at least, encryption and decryption, identity verification, and data authentication.

39. The method according to claim 37 wherein said security functions comply with HIPAA requirements.

40. The method according to claim 22 further comprising the step of periodically reviewing adjudicated payment requests for accuracy.

41. The method according to claim 40, further comprising the steps of tracking payments and detecting fraudulent service delivery patterns.

42. A system for processing health insurance claims that require expert review comprising:
a series of processors distributed between a provider and an insurance carrier wherein said processors cooperate through a communications link to:
generate and securely store a treatment plan file containing a plan of treatment and supporting data related to said insurance claim;
provide guidelines for conducting said expert review;
process applications by experts for reviewing said treatment plan and assign an expert to review said treatment plan; and
wherein said series of processors are selectably accessible to allow an expert to apply to review a treatment plan, have limited and secure access to said treatment plan, and generate a report assessing said treatment plan.

43. A system for processing health insurance claims, according to claim 42 wherein said series of processors further includes a web site and said functions are distributed among said processors.

44. A system for processing health insurance claims, according to claim 42, wherein said expert obtains access to said series of processors using a remote computer device operatively connected to said processors through a communication link.

45. A system for processing health insurance claims, according to claim 42, wherein said communication link includes an Internet site.

46. A system for processing health insurance claims according to claim 42, wherein said series of processors include communication interfaces which connect to said communication link to provide security functions to protect and to keep private any data in transit, in processing, or in storage.
